(19) United States
(12) Patent Application Publication
(10) Pub. No.: US 2008/0313340 A1
(43) Pub. Date: Dec. 18, 2008

(54) Method and apparatus for sending and receiving content with associated application as an object

(75) Inventors: Charles Liu, Chapel Hill, NC (US); William O. Camp, JR., Chapel Hill, NC (US); Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/125,140

(22) Filed: May 22, 2008

Related U.S. Application Data
(60) Provisional application No. 60/944,387, filed on Jun. 15, 2007.

(51) Int. Cl. G06F 15/16

(52) U.S. Cl. 709/228

(57) ABSTRACT

Techniques for sending a data object to a user of a communication device are disclosed. The technique comprises the steps of: monitoring the occurrence of a trigger on a first communication device; and transferring, upon the occurrence of the trigger, a data object to a second communication device, wherein the data object comprises content and at least one associated application based on at least one capability of the second communication device.

### RELATED APPLICATIONS

The present application claims priority under 35 U.S.C. Section 119(e) to U.S. Provisional Patent Application 60/944,387, filed Jun. 15, 2007, the entire contents of which are incorporated by reference herein.

### TECHNICAL FIELD

The present invention relates generally to a method and apparatus for exchanging information in a communication system. More specifically, the invention relates to methods and apparatus for exchanging data objects comprising content as well as associated applications.

### BACKGROUND

With the convergence of voice and data communication networks, portable communication devices are increasingly likely to support several communication modes, as well as a number of communication-related applications. Single-purpose cellular phones and alphanumeric pagers have given way to complex mobile devices supporting voice communications, e-mail, and instant messaging. A typical device often includes a camera, a music player, and sound recorder, and may include a global positioning system (GPS) receiver. Many of these devices and their supporting wireless networks now enable simultaneous use of multiple communication modes. Thus, a device user today might engage in a voice call and simultaneously send or receive text messages, digital images, video clips, or the like.

A few applications have been developed to take advantage of this simultaneous availability of multiple communications modes. In particular, several patents and patent application publications describe a so-called Phone Pages system, in which the generation and transfer of multimedia data objects is triggered by various communication-related events. These data objects, or Phone Pages, thus supplement a primary communication session, such as a voice call, an e-mail exchange, or an instant message conversation. The Phone Pages concept is described in the following patents and patent application publications, the contents of which are each incorporated by reference herein: U.S. Pat. No. 6,922,721, titled “Exchange of Information in a Communication System” and issued on Jul. 26, 2005 to Minborg et al.; U.S. Patent Application Publication 2005/0271041 A1, titled “Exchange of Information in a Communication System” and filed on Jun. 1, 2005 by Minborg et al.; U.S. Pat. No. 6,996,072, titled “Method and Apparatus for Exchange of Information in a Communication Network” and issued on Feb. 7, 2006 to Minborg; U.S. Pat. No. 6,977,909, titled “System and Method for Exchange of Information in a Communication Network” and issued on Dec. 20, 2005 to Minborg; and U.S. Patent Application Publication 2006/0114845, also titled “System and Method for Exchange of Information in a Communication network” and filed on Nov. 14, 2005 by Minborg.

The communication techniques and systems described in the preceding references provide a variety of enhancements to conventional modes of communication, facilitating the convenient exchange of various data objects between users of communications devices. These enhancements may be quite valuable both for promoting personal relationships and for supporting business and enterprise communications. However, without appropriate mechanisms for regulating their transfer, the increased flow of data objects may be overwhelming, both for system users and for the system itself.

### SUMMARY

As noted above, improved techniques for regulating the automatic transfer of data objects in communication systems are needed. In particular, current systems and methods do not provide the ability to send and receive content and associated applications in the form of data objects, particularly when those users are engaged in a primary communication with each other. The techniques disclosed herein overcome the above identified deficiencies of providing the ability to send and receive content and associated applications in the form of data objects, particularly when those users are engaged in a primary communication with each other.

According to some embodiment of the systems and methods described herein, methods for sending a data object to a user of a communication device are provided. An exemplary method comprises the steps of: monitoring the occurrence of a trigger on a first communication device; and transferring, upon the occurrence of the trigger, a data object to a second communication device, wherein the data object comprises content and at least one associated application based on at least one capability of the second communication device.

In another embodiment of the various systems and methods described herein, a system for supplying a data object to a user of a communication system is provided. An exemplary system thus comprises a first communication device in communication with a second communication device, wherein the first communication device includes: (i) logic for: monitoring the occurrence of a trigger on the first communication device; (ii) logic for: upon the occurrence of the trigger, transferring or requesting a transfer by a data object server of a data object to the second communication device, wherein the data object comprises content and at least one associated application based on at least one capability of the second communication device.

In yet another embodiment of the various systems and methods described herein, a device for supplying a data object to a user of a communication device is provided. An exemplary device comprises computer software stored on a computer-readable media executable to perform: (i) monitoring the occurrence of a trigger on a first communication device; and (ii) transferring or requesting a transfer by a data object server of, upon the occurrence of the trigger, a data object to the second communication device, wherein the data object comprises content and at least one associated application based on at least one capability of the second communication device.

In still another embodiment of the various systems and methods described herein, a downloadable application or module for supplying a data object to a user of a communication device, the downloadable application or module being stored on a computer-readable media executable to perform: (i) monitoring the occurrence of a trigger on a first communication device; (ii) transferring or requesting a transfer by a data object server of, upon the occurrence of the trigger, a data object to a second communication device, wherein the data object comprises content and at least one associated application based on at least one capability of the second communication device.

Embodiments of a communication device configured to selectively deliver a data object to another communication device are also disclosed, as are embodiments of a data object server in accordance with several aspects of the invention. Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

The invention will now be more thoroughly described and features and advantages will become readily apparent by reading the following detailed description, where references will be made to the accompanying figures, where:

FIG. 1 illustrates an overview of a communication infrastructure overview according to one embodiment of the invention;

FIG. 2 illustrates an overall system for providing a data object to a user of a communication device;

FIG. 3 illustrates a method for sending a data object;

FIG. 4 is a block diagram illustrating an exemplary communication device; and

FIG. 5 is a block diagram illustrating an exemplary data object server.

### DETAILED DESCRIPTION

The present invention is described below in reference to a wireless telecommunications system providing voice and data services to a mobile device. Various systems providing voice and data services have been deployed, such as GSM networks (providing circuit-switched communications) and GPRS (providing packet-switched communications); still others are currently under development. These systems may employ any or several of a number of wireless access technologies, such as Time Division Multiple Access (TDMA), Code Division Multiple Access (CDMA), Frequency Division Multiple Access (FDA), Orthogonal Frequency Division Multiple Access (OFDMA), Time Division Duplex (TDD), and Frequency Division Duplex (FDD). The present invention is not limited to any specific type of wireless communications network or access technology. Indeed, those skilled in the art will appreciate that the network configurations discussed herein are only illustrative. The inventive techniques disclosed herein may be applied to “wired” devices accessing conventional voice or data networks, as well as wireless devices. The invention may be practiced with devices accessing voice and/or data networks via wireless local area networks (WLANs) or via one or more of the emerging wide-area wireless data networks, such as those under development by the 3rd-Generation Partnership Project (3GPP).

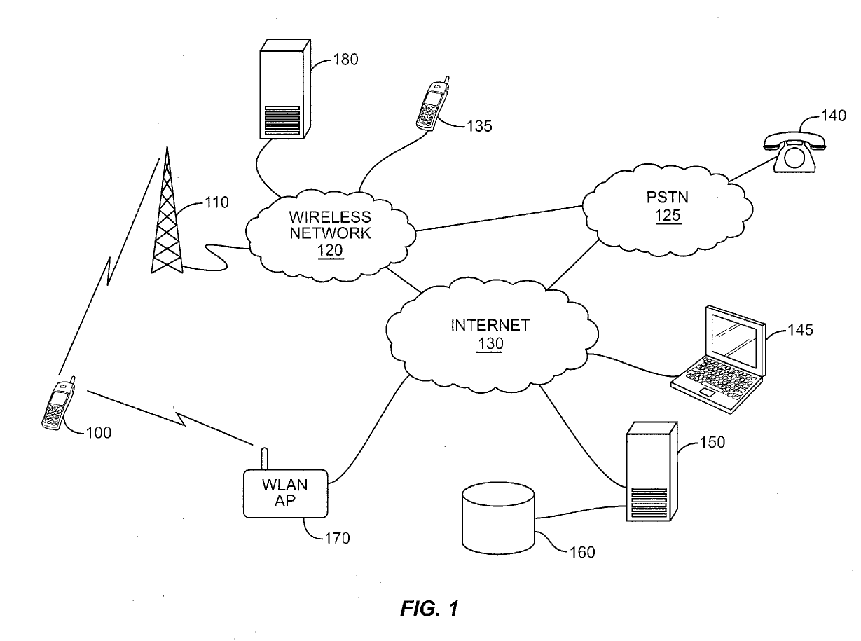

FIG. 1 illustrates an exemplary communications system in which the present invention may be employed. Communications device 100 communicates with other devices through base station 110, which is connected to wireless network 120. Wireless network 120 is in turn connected to the Public Switched Telephone Network (PSTN) 125 and the Internet 130. Wireless device 100 can thus communicate with various other devices, such as wireless device 135, conventional land-line telephone 140, or personal computer 145. In FIG. 1, wireless device 100 also has access to data server 150 via the Internet 130; data server 150 may be configured to provide access through Internet 130 to data or applications stored in storage device 160. Storage device 160 may comprise one or more of a variety of data storage devices, such as disk drives connected to data server 150 or one or more other servers, a Redundant Array of Inexpensive Drives (RAID) system, or the like.

Communications device 100 may be a cordless telephone, cellular telephone, personal digital assistant (PDA), communicator, computer device, or the like, and may be compatible with any of a variety of communications standards, such as the Global System for Mobile Communications (GSM) or one or more of the standards promulgated by 3GPP. Communications device 100 may include a digital camera, for still and video images, as well as a digital sound recorder and digital music player application. Communications device 100 may also support various applications in addition to voice communications, such as e-mail, text messaging, picture messaging, instant messaging, video conferencing, web browsing, and the like.

Communications device 100 also includes a wireless local-area network (WLAN) transceiver configured for communication with WLAN access point 170. WLAN access point 170 is also connected to Internet 130, providing communications device 100 with alternative connectivity to Internet-based resources such as data server 150.

Also connected to wireless network 120 is location server 180. Location server 180 is typically maintained by the operator of wireless network 120, but may be separately administered. The main function of location server 180 is to determine the geographic location of mobile terminals (such as mobile terminal 100) using the wireless network 120. Location information obtained by location server 180 may range from information identifying the cell currently serving mobile terminal 100 to more precise location information obtained using Global Positioning System (GPS) technology.

Other technologies, including triangulation methods exploiting signals transmitted from or received at several base stations, may also be used to obtain location information. Triangulation techniques may include Time Difference of Arrival (TDOA) technology, which utilizes measurements of a mobile's uplink signal at several base stations, or Enhanced-Observed Time Difference (E-OTD) technology, which utilizes measurements taken at the mobile terminal 100 of signals sent from several base stations. GPS-based technologies may include Assisted-GPS, which utilizes information about the current status of the GPS satellites derived independently of the mobile terminal 100 to aid in the determination of the terminal's location.

In some embodiments, the various systems and methods described herein facilitate the selective delivery of data objects to a communication device, such as mobile terminal 135, in communication with another device, such as mobile terminal 100. The data object may be transferred from one device to the other, e.g., from mobile terminal 100 to mobile terminal 135, or from a data object server, such as server 150 or server 180, in response to a request from either of the communication devices.

Typically, the users of the communication devices are engaged in a communication session, which may comprise a voice call (whether circuit-switched or packet-switched), an instant message (IM) session, or any other modes of communication such as those described herein or combinations thereof. In some embodiments, one or both of the communication devices may include a module or application that is able to determine the occurrence of a communications-related trigger event in the communication device and to thereafter transmit and/or receive data, such as data specifically related to the trigger event. The trigger event may comprise, for example, any of the following events or combinations thereof:
the establishment of a session or call between the devices;
the arrival or departure of a device in a multi-party communication session;
activation by the user of one or both of the communication devices (e.g., an explicit request by one user for transfer of a data object to the other);
timer-based periodic or random trigger event in communication device;
crossing a geographic boundary, such as a boundary established by the user of one of the communication devices; or
other events related to the communication, such as those described in U.S. Pat. No. 6,996,072.

Other trigger events might include, but are not limited to:
An outgoing call is or is about to be initiated.
A called party answers a call.
A called party is busy.
A called party does not answer after a pre-determined time or number of rings.
A called party rejects a call.
A called party is unavailable (e.g., an addressed mobile phone is out of coverage).
An incoming call is imminent or has just started.
A conference call is or is about to be initiated.
A call is disconnected.
A call is conducted (under which several triggering events can be generated).
A party is placed on hold.
The location of a party has changed.
A communication device is switched on or off.
A special-function button is pressed on a communication device.
A button or other user interface device is activated in response to a query.
A voice mail, text message, e-mail, instant message, or the like is received.
A voice mail, text message, e-mail, instant message, or the like is received.

While many of the preceding trigger events are related to traditional voice communications, those skilled in the art will appreciate that many analogous trigger events will apply to other communication modes, such as instant messaging, e-mail, video conferencing, “chat” sessions, and so on.

According to some embodiments of the present invention, the various systems and methods described herein may provide the ability for users to send and receive data objects that include content, e.g., multimedia content, as well as an associated application, e.g., an application for decrypting, decoding, and/or rendering the multimedia content. In several embodiments, one or more of these data objects are exchanged in connection with a primary communication between two or more users.

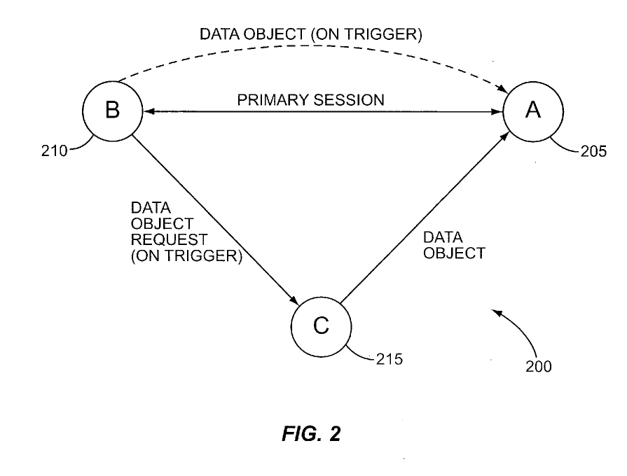

FIG. 2 illustrates a system 200 depicting a first communication device A 205, a second communication device B 210, and a data object server C 215. In some embodiments, communication devices A 205 and B 210 may comprise any of the User Equipments (UE) described in this application, such as, for example, UE 100 of FIG. 1, and data object server 215 may comprise any of the data object servers described herein, such as data object server 150 or 180 of FIG. 1 or any of the Phone pages servers described herein.

In some embodiments, the various systems and methods described herein may enable communication devices A 205 and B 210 to—upon the occurrence of a trigger event, for example—transmit and receive data objects, or “Phone Pages.” These Phone Pages may comprise content as well as an associated application(s) that are desired by communication device A 205, or any other data or information that may be transmitted via data objects or Phone Pages. Such data or information may be stored within each such device or within a remote server, database or other storage device.

As shown, the users of communication devices A 205 and B 210 are engaged in a primary communication session. Such a communication session may comprise a voice call (e.g., circuit or VoIP), instant message (IM) session, or any other modes of communication such as those described herein or combinations thereof. Of course, those skilled in the art will appreciate that more than two users may participate in the primary communication session.

In any event, in some embodiments, either or both of communication devices A 205 and B 210 includes a module or application that is able to determine the occurrence of an event associated with the primary communication session, such as one of the triggering events described above. In response to the trigger event, one or both communication devices may transmit and/or receive data and information, such as any desired content and associated applications or modules required to render the content, for example.

In some embodiments, during establishment of the call or session with communication device B 210, an application in communication device A 205 may directly send to communication device B 210 information about the capability(ies) of communication device A 205, such as, for example, its screen size or resolution, available codecs, or other rendering capability of communication device A 205.

In some embodiments, during the session or call with communication device B 210, a triggering event may occur at one or both of communication devices A 205 and B 210. The trigger event may comprise any of the trigger events described above, or may comprise the receipt of capability information corresponding to one of the communications devices. In response to the trigger, an application in communication device B 210, for example, may directly send a data object to communication device A 205 containing the desired content and associated application. Alternatively, communication device B 210 may transmit a request to data object server C 215 for it to send a data object to communication device A 205. In the latter case, the request to data object server C 215 may include the identity and the capability(ies) of communication device A 210.

Upon receipt of the request, data object server C 215 may create a data object and transfer it to communication device A 205. In some embodiments, the data object may comprise data and information related to the trigger event, data or information that is stored in communication device A 205, or any other data or information that may be transmitted via phone pages or data objects.

When data object server C 215 receives the information from user B, it may create a data object specifically optimized for User A's device. In some embodiments, the data object contains content, e.g., multimedia content, as well as the corresponding application needed to properly render the content on the User A's device. The selection of the content and/or the corresponding application may be based on the target device's capability. For example, if a specific encoded video or audio clip is selected, the data object may include the selected clip as well as a decoding application or plug-in, for use by the receiving device in playing back the clip. In another example, the data object may include a multimedia object along with the metadata for an associated JAVA program, for use in rendering animation from the multimedia object. In some embodiments, the data object includes a file containing a complete application or plug-in corresponding to the content included in the object. In others, the data object may include the content as well as a link (e.g., a Uniform Resource Locator, URL) that the target device may use to access and render the included content. In yet others, the data object includes a URL link to streamed content, along with a player for rendering the streamed content.

Thus, when the target device receives the data object from server C 215, it may launch the application included in the data object to process (e.g., to decrypt, decode, render, etc.) the metadata/content coming with it or streaming down to the device. In embodiments where the selection of the content and/or the associated application is made in view of the target device's capabilities, then the rendering quality may be optimized to the target device.

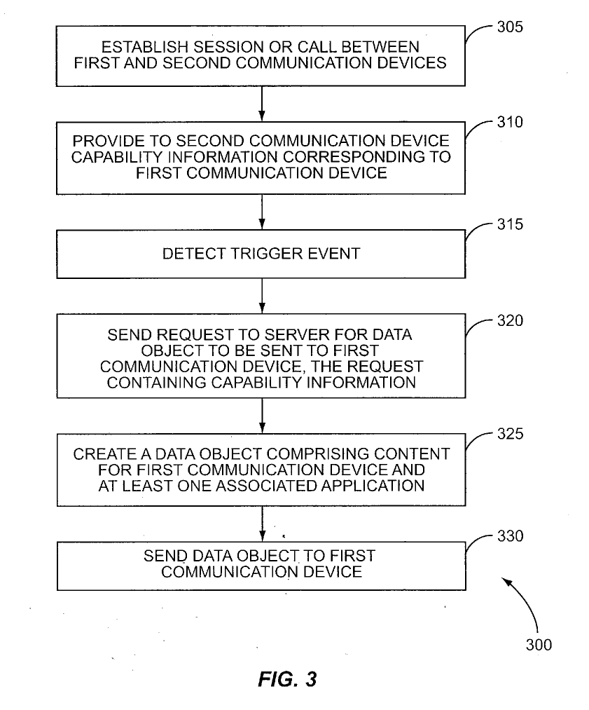

FIG. 3 illustrates an embodiment of a method 300 for sending content with associated application(s) as a data object. At step 305, a session or call is established between first and second communication device. In some embodiments, such session or call is initiated so that the first communication device may obtain desired content from or through the second communication device. At step 310, the first communication device provides to the second communication device information about the capability(ies) of the first communication device. For example, in some embodiments, such capability(ies) may comprise the screen resolution of the first communication device, or other processing feature or capability. At step 315, a trigger event is detected by the second communication device. At step 320, the second communication sends a request to a data object server to send a data object to the first communication device In some embodiments, the request may include information about the capability(ies) of the first communication device. At step 325, a data object is created, where the data object comprises content desired by the first communication device and at least one associated application. Finally, at step 330, the data object is sent to the first communication device; upon receiving the data object the first communication device may use the included application to process the included content.

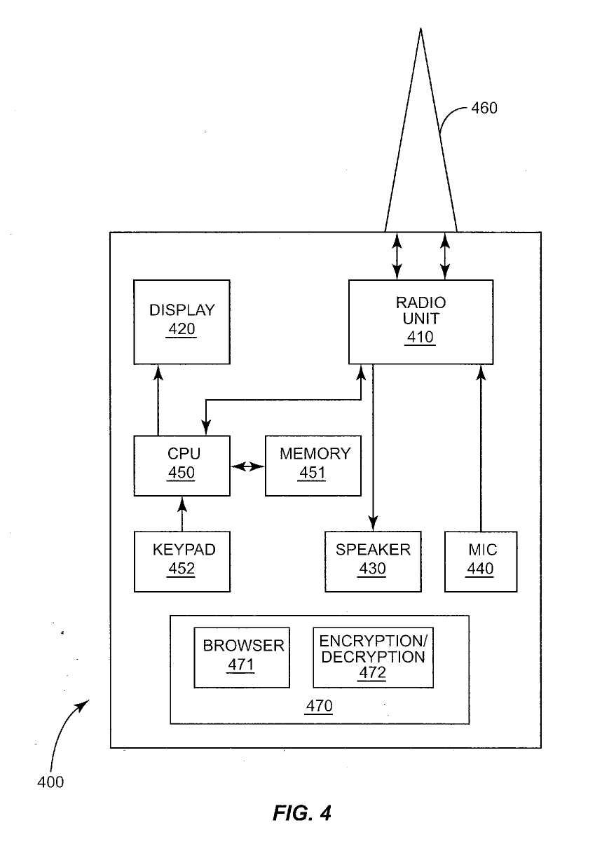

FIG. 4 illustrates an exemplary communication device 400 to be used in one or more embodiments of the present invention. In the pictured embodiment, communication device 400 may comprise a mobile telephone, or a personal digital assistance (PDA) device with mobile telephone capabilities. Communication device 400 includes a central processing unit (CPU) 450, connected to at least one memory unit 451, and at least one display 420. The CPU 450 may also be connected to a keyboard device or area 452 to allow subscribers to enter, for example, digits or alphanumeric characters. The memory unit 451 may include non-volatile memory (e.g., flash, EEPROM or SIM card) in order to retain stored information, should power be temporarily unavailable.

The CPU 450 is further connected to a radio unit 410 configured to convert incoming and outgoing data to and from radio frequency (RF) modulated signals. The radio unit 410 also connects to an antenna 460 for transmission and reception of the RF signals. Radio unit 410 may also directly or indirectly be connected to an earphone 430 and a microphone 440 in order to allow voice communication. Communication device 400 may further comprise a plurality of programs 470, such as a browser 471, that can render at least one type of data object, and an encryption/decryption engine 472, allowing data object requests to be encrypted and data objects to be decrypted. Communication device 400 may optionally be equipped with a cache memory in which it is possible to store and retrieve data objects without occupying transmission resources within the communication network.

In some embodiments of the present invention, CPU 450 and/or other processing logic included in communication device 400 is configured to carry out one or more of the methods described above. In particular, communication device 400 may comprise processing logic configured to provide capability information to another device, wherein the capability describes rendering capabilities for communication device 400, such as screen size and resolution, available codec types, etc. The processing logic of communication device 400 may be further configured to detect the occurrence of a trigger event, the trigger event related to communication between device 400 and a second communication device. In response to the trigger event, the processing logic is configured to transmit a data object to the second communication device, or to request that a data object be sent to the second communication device. In the first case, the processing logic may be configured to assemble the data object based on rendering capabilities information corresponding to the target device. In the latter case, the processing logic may be configured to include capabilities information for the target device in the request sent to a data object server.

The data object, as discussed above, comprises content, e.g., multimedia content, for the target device, as well as an associated application, such as an application for rendering the content. Thus, upon receipt the target device may use the associated application for rendering the content.

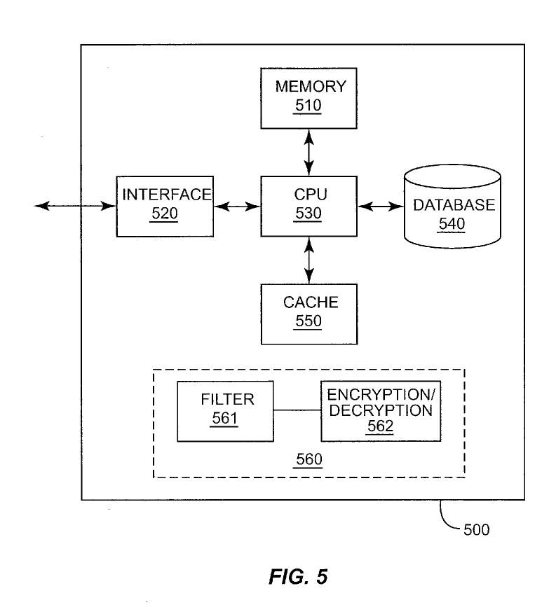

FIG. 5 illustrates a data object server 500 according to one or more embodiments of the present invention. Data object server 500 comprises at least one CPU 530 connected to at least one memory device 510, a cache memory 550, at least one database 540 and at least one network interface 520. Memory devices 510 and databases 540 may include non-volatile memory, such as flash, magnetic, or optical storage devices. Network interface 520 enables the CPU 530 to send and receive data to/from the data network 130. The cache memory 550 allows storage of frequently used data objects so that the CPU 530 may obtain them readily. The database 540 contains the actual data objects that can be requested by a communication device, such as communication device 400, via, for example, the wireless network 120 and Internet 130 pictured in FIG. 1. The data object server may further comprise a number of programs 560 including, but not limited to, a filter 561, allowing the data objects to be optimized according to the rendering capabilities of the communication device 400, and an encryption/decryption engine 562, allowing data object requests to be decrypted and data objects to be encrypted.

In some embodiments of the present invention, the data object server 500 is configured to carry out one or more of the methods described above. In particular, data object server 500 may comprise processing logic (e.g., CPU 530, configured with appropriate software) configured to detect the occurrence of a trigger event associated with communication between a first and second communication device. In some embodiments, the trigger event is detected by the receipt of a data object request from the first communication device. In response to the trigger event/trigger event message, the data object server is configured to retrieve or form a data object containing content and an associated application as described above. In some embodiments, this comprises retrieving the data object from database 540 or cache 550; in other embodiments or circumstances this may comprise requesting a data object from a remote data object server and receiving the data object in response.

Those skilled in the art will appreciate that the various functions of communication device 400 and data object server 500 may be performed using various combinations of hardware and software. Accordingly, each of the described processing blocks may in some embodiments directly correspond to one or more commercially available or custom microprocessors, microcontrollers, or digital signal processors. In other embodiments, however, two or more of the processing blocks or functional elements of device 400 or data object server 500 may be implemented on a single processor, while functions of other blocks are split between two or more processors. Likewise, memories 451 and 510 are representative of the one or more memory devices containing the software, firmware, and data used to implement base station functionality in accordance with one or more embodiments of the present invention. Thus, these memory devices may include, but are not limited to, the following types of devices: cache, ROM, PROM, EPROM, EEPROM, flash, SRAM, and DRAM.

Those skilled in the art should appreciate that the present invention broadly provides methods and apparatus for selectively transferring data objects to a communication device. The present invention may, of course, be carried out in other specific ways than those herein set forth without departing from the scope and essential characteristics of the invention. Thus, the present invention is not limited to the features and advantages detailed in the foregoing description, nor is it limited by the accompanying drawings. Indeed, the present invention is limited only by the following claims, and their legal equivalents.

What is claimed is:

1. A method for sending a data object to a user of a communication device, comprising the steps of:
monitoring the occurrence of a trigger on a first communication device;
transferring, upon the occurrence of the trigger, a data object to a second communication device, wherein the data object comprises content and at least one associated application based on at least one capability of the second communication device.

2. The method of claim 1 wherein in the data object is sent from a data object server to the first communication device.

3. The method of claim 1 wherein the trigger comprises establishing a session or call, a timer-based periodic or random event, or a manual activation.

4. The method of claim 1 wherein the first and second communication devices each comprises a mobile communication device.

5. The method of claim 1 wherein the data object is transferred to the second communication device upon receipt of a request at a data object server.

6. The method of claim 5, wherein the request comprises capability information corresponding to the second communication device.

7. A method for sending a data object to a user of a communication device, comprising the steps of:
receiving capability information at a first communication device, the capability information corresponding to a second communication device;
monitoring the occurrence of a trigger on a first communication device;
sending a data object transfer request to a data object server, wherein the data object transfer requests the transfer of a data object to a second communication device, wherein the data object comprises content and at least one associated application based on at least one capability of the second communication device.

8. The method of claim 8, wherein the data object transfer request comprises the capability information for the second communication device.

9. A system for supplying a data object to a user of a communication system, comprising a first communication device in communication with a second communication device, wherein the first communication device includes
logic for monitoring the occurrence of a trigger on the first communication device; and
logic for, upon the occurrence of the trigger, transferring or requesting a transfer by a data object server of a data object to the second communication device, wherein the data object comprises content and at least one associated application based on at least one capability of the second communication device.

10. The system of claim 9, wherein the first communication device includes logic for requesting a transfer by the data object server of the data object to the second communication device, wherein the request includes capability information corresponding to the second communication device.

11. The system of claim 9, wherein the trigger comprises establishing a session or call, a timer-based periodic or random event, or a manual activation.
